(19) United States
(12) Patent Application Publication
(10) Pub. No.: US 2026/0051142 A1
(43) Pub. Date: Feb. 19, 2026

(54) MODEL TO INFER USER CHARACTERISTICS BASED ON IMAGES

(71) Applicant: Disney Enterprises, Inc., Burbank, CA (US)

(72) Inventor: Fabian Gallusser, Palo Alto, CA (US)

(73) Assignee: Disney Enterprises, Inc., Burbank, CA (US)

(21) Appl. No.: 18/808,866

(22) Filed: Aug. 19, 2024

(51) Int. Cl. G06V 10/44; G06T 11/00

(52) U.S. Cl. CPC G06V 10/44; G06T 11/00

(57) ABSTRACT

In some embodiments, a method receives an image representation to represent an account for a service. The image representation is analyzed to extract a set of first features of characteristics of the image representation. The method determines a set of second features that are different from the set of first features. The set of first features and the set of second features are input into a model to generate a prediction for the service. The prediction is used to perform an action on the service for the account.

### BACKGROUND

A company may provide a service to user accounts. When a new user account creates a new account for the service, the company may not have very much, if any, information about the user that is using the user account. This may be referred to as a cold start problem in which the service does not have much or any information on the user account to customize aspects of the service to provide to the user account. For example, the lack of information or data may make drawing inferences or providing the service in a customized manner difficult. Some companies may address the problem by asking users to provide some information during the signup process, such as by answering questions of a survey, but this may be cumbersome and time-consuming for the user, which may result in the user not answering the questions.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 depicts a simplified system for analyzing image representations according to some embodiments.

FIG. 2 depicts a simplified flowchart of a method for determining image features according to some embodiments.

FIG. 3 depicts a simplified flowchart of a method for determining user personalization actions according to some embodiments.

FIG. 4 depicts a simplified flowchart of a method for performing training according to some embodiments.

FIG. 5 depicts a simplified flowchart of a method for adjusting weights for image features according to some embodiments.

FIG. 6 depicts a more detailed example of a personalization model according to some embodiments.

FIG. 7 illustrates one example of a computing device according to some embodiments.

### DETAILED DESCRIPTION

Described herein are techniques for a data analysis system. In the following description, for purposes of explanation, numerous examples and specific details are set forth to provide a thorough understanding of some embodiments. In some embodiments as defined by the claims may include some or all the features in these examples alone or in combination with other features described below, and may further include modifications and equivalents of the features and concepts described herein.

### System Overview

A service for a company may receive representations for user accounts, which may include image representations, screen name representations, and other representations. For example, a selection from a user associated with a user account may be received for associating an image representation with a profile for the service. In some embodiments, the image representation may be a character, such as an avatar. The character may represent the user on the user's profile, such as via an icon on a user interface. The selection of the image representation for the profile may be part of a signup process of the service, or a part of creating a profile. The use of the image representation may be optional for the profile, but may be quickly configured by a user. The selection of the image representation may also be changed after signup.

The image representation may include characteristics that can be used to determine and perform an automatic user personalization action. In some embodiments, based on characteristics of the image representation, a user interface may be automatically customized, such as tiles in a homepage may be rearranged to make preferred tabs more easily accessible, adjust a display of preferred tiles in more relevant areas of the user interface, color/mood of the layout, etc. Additionally, tailored messaging may be automatically generated and performed based on characteristics of the image representation. Other actions may also be determined and performed.

The use of the image representation to perform the user personalization action may improve the determination of the user personalization action. The selection of the image representation is an efficient process that may be performed when a user sets up a profile. For example, the image representation is visibly tied to the profile, and a user may be focused on selecting an appropriate image representation for the profile. Also, the selection of the image representation is not as burdensome as responding to multiple questions in a survey. The characteristics that are determined from the image representation may also be important. For example, if the image representation is of an animated character, then the user account may be interested in children stories or cartoons. However, if the image representation is associated with a specific brand or a science fiction character, then the user account may be interested in content associated with space or science fiction content. These features from the image representation may be input into a model that determines the user personalization action. The model may be trained using outcomes of other users that have selected image representations to adjust its parameters. The model is then able to use these features to generate a prediction that is used to determine the user personalization action. During a cold start situation, such as in a time period right after signup when other information about the user is limited and not available (e.g., a watch history of content is not existent or limited or other use of the service by the user is not existent or limited, the use of the features allows the model to generate improved predictions during the cold start period). For example, some services may typically use models that require history of the user using the service, such as services including service disengagement prediction, re-engagement prediction, likelihood of watching titles, product switch prediction, user demographics (age, gender, household size . . . ), user segmentation, etc. Also, models that customize emails (background, font, style) to users who have just signed up to the service may receive customized emails similar to emails that are customized for users that had used the service for a while. The user interface may be initially customized instead of using a generic interface that is provided to all new users.

### System

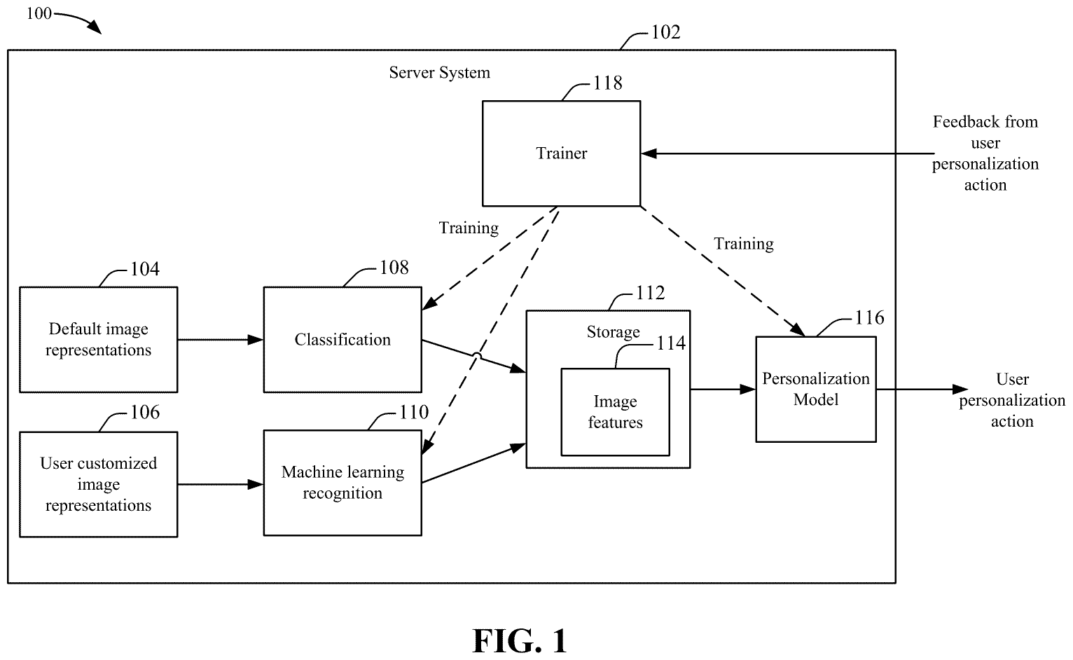

FIG. 1 depicts a simplified system 100 for analyzing image representations according to some embodiments. A server system 102 may analyze image representations and output a user personalization actions.

In some embodiments, the image representations may be of different types. For example, image representations may be default image representations or user customized image representations. An image representation may be a single character, multiple characters, characters with objects, or other content. At 104, default image representations may be received. The default image representations may be fixed image representations that may be selected by user accounts. The service may offer the default image representations, which cannot be customized by users. That is, a user may select one of the default image representations. In some embodiments, default image representations may be different characters.

At 106, user customized image representations may be received. The user customized image representations may be customized by a user account. In some embodiments, the user customized image representations may be created or modified by the user account. For example, a template may be used to create a user customized image representation. In some embodiments, a user may customize parts of the image representation, such as hair color, eye color, etc. Additionally, a picture may be uploaded, such as a picture of the user, which can then be integrated into the image representation. Also, the user customized image representation may be created by the user account using a tool and uploaded to the service. The difference between the default image representations and the user customized image representations is that default image representations may be selected by users, and not customized, whereas customized image representations may be customized by users. User customized image representations may be different based on the user customizations that are received. However, multiple user accounts that select the same default image representation are associated with the same image representation.

The different types of image representations may be analyzed differently to determine features from the image representation. For default image representations, at 108, a classification process is performed. The classification may be automated or manual. For example, based on the characteristics of a default image representation, the classification process may determine image features, such as mood, color, brand, cartoon, humanoid, etc. In some embodiments, characteristics for default image representations may include a brand characteristic, an age range characteristic, a humanoid characteristic, a cartoon characteristic, but are not limited to these characteristics and other characteristics may also be used. The brand may be associated with the brand of the content, such as the name or company that created the content. Age range may be whether the image representation is associated with a certain age range. Humanoid may be whether the character is human or not human. Cartoon may be whether the content associated with the default image representation is a cartoon or not. These characteristics may be mapped to values for the image features. For example, the characteristics may be mapped to values for the image features, such as the age range characteristic may be mapped to an age range value, the humanoid characteristic is mapped to a yes or no value, the cartoon characteristic is mapped to a yes or no value, and the brand characteristic is mapped to a name of the brand. Other values may also be used, such as an age range for the age range characteristic may be used. In some embodiments, the classification process may map each respective default image representation to a default set of values for the image features. The values would be the same whenever the default image representation is selected.

User customized image representations may include different characteristics depending on the customization by the user. In some embodiments, at 110, a recognition process, such as a machine learning recognition process, is used. The machine learning recognition process may receive the user customized image representation, analyze the characteristics of the user customized image representation, and output image features. The machine learning recognition process may analyze the image representation, to determine characteristics of the image representation, such as whether the image is from a cartoon or live action, how dark the image is, how many people are present, which brand the image belongs to, other information. A model for the machine learning recognition may be trained to recognize characteristics of user customized image representations, and output values for the image features. In some embodiments, the output of the machine learning recognition process may be an embedding in a space. The embeddings may be numerical representations of real world objects that machine learning and artificial intelligence systems use to understand complex knowledge domains. For example, the embedding may represent the characteristics of the user customized image representation in a higher dimensional space. Different values for the image features may be represented by an embedding in different areas of the space. In other embodiments, the machine learning recognition process may output the values for the image features, which may be similar to the values from the classification process of the default image representations. Depending on the user customization, the value for the image features may be different.

The different methods of analyzing different types of image representations may improve the process of determining characteristics. For example, providing a machine learning recognition of user customized image representations allows a consistent determination of characteristics for user customized content that may not be known beforehand. This allows user customized image representations to be used with default representations.

Storage 112 may store the values for the image features at 114. These image features may then be used to determine a user personalization action. For example, a personalization model 116 receives the values for the image features as input, and generates a prediction that is used to determine the user personalization action. The prediction may depend on what action is desired. For example, the prediction may predict a category for the user, such as an age range, a content category (e.g., likes science fiction), or other characteristics. In some examples, inputs may include features gathered from the image representation, cartoon vs movie, brand, number of characters, character behavior, character emotions. Other inputs that are not from the image representation could be included for modeling, e.g., time at which the use signed-up, device the user signed-up on, and other features. Other inputs may be determined based events that are associated with the image representation, such as on information around the image: how long did it take the user to select this image, how many times did the user edit/change the image, did the user select an image for each profile, the number of profiles have an image associated, etc. Some examples of output may be (1) brand preferences (e.g., fantasy versus superhero versus nature), (2) in-application personalization (next titles to recommend, order of sets, format and layout of homepage, background and font customization, etc.), (3) off-application personalization (e.g., when to contact users via email or push messages, what content to promote, style and font user for messaging, etc.).

The user personalization action may be different actions, such as action may personalize the user interface, may be a prediction of if the user will continue with the service, recommendations, content for a message to the user, etc. For example, a first user personalization action may be to adapt the font for some text in the user interface, such as some brands of content may have different fonts depending on categories of the user. For example, font settings may be predicted and can be used to adjust the font for the user interface. Also, the grid layout and size may be adjusted. For example, the layout for certain brands of content may be increased that may be considered popular for the image features while a size of the layout of other brands that may be considered not as important to the image features may be reduced. The prediction may output sizes for brands that are used to adjust the layout for the user interface. Also, the image features may be used to generate recommendations for the user account, such as recommendations on which content to watch first based on the image features. For example, the recommendations may be based on content that was watched by other users that had similar image representations. Further, the user interface may be customized by adjusting a background image or the color scheme based on the image features.

A training process may also be performed. Personalization model 116 may use a data-driven approach where user accounts that selected image representations may have previously performed user personalization actions. For example, a trainer 118 may train the classification process at 108, the machine learning recognition process at 110, or personalization model 116. The training process may use a known outcome for a selection of an image representation to train parameters for the classification process at 108, the machine learning recognition process at 110, or personalization model 116. For example, the image features of the image representation may be input into personalization model 116 to generate a prediction. The prediction is then compared with the known outcome to generate a loss, and the difference is used to adjust the parameters to reduce the loss.

Also, a trainer 118 may receive feedback from the user personalization action. The feedback may be based on action performed or state of the user account, such as which instance of content is selected that is customized on the user interface, whether the user account continued with the service, a feature category that the user account was classified, etc. Then, trainer 118 may train the classification process at 108, the machine learning recognition process at 110, or personalization model 116. The training may adjust parameters of any of the processes based on to allow the processes to either better determine image features from default image representations or user customized image representations, or generate better predictions for user personalization actions from image features.

The prediction of the personalization model may be improved using the extra features from the image features. Previously, features from the user account may have been used, where upon sign up, not much about the user account may be known. Thus, the values for these features may not be accurate or the features are not used. However, the image features from the image representation may have a good correlation to an outcome. For example, other users that have selected the image representation may have resulted in certain outcomes. The correlation between the image representation and the outcome may be strong and may provide a better prediction from personalization model 116 compared to using the other features about the user account. This is an improvement in the operation of personalization model 116 by training personalization model 116 to process the image features for the image representation.

The following will now describe the feature determination process in more detail.

### Feature Determination

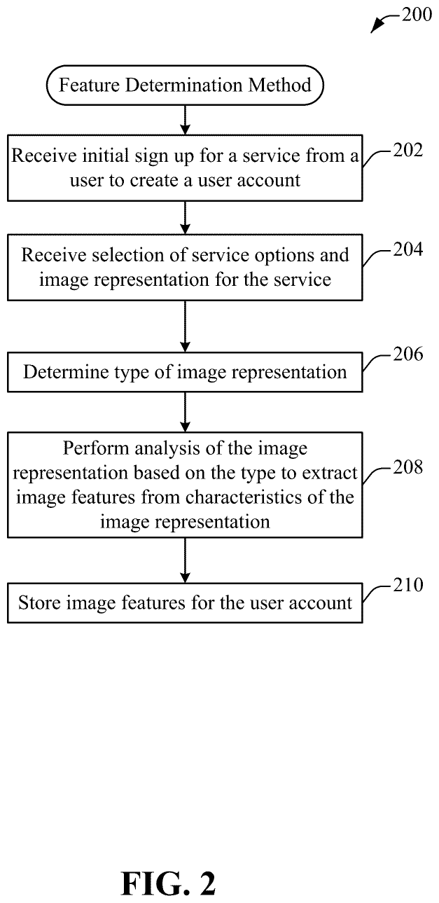

FIG. 2 depicts a simplified flowchart 200 of a method for determining image features according to some embodiments. At 202, server system 102 receives an initial sign up for a service from a user to create a user account. Although this process is discussed with respect to an initial signup, the image representation may be received at different times. For example, the user account may change image representations over time while using the service, create a new image representation after not selecting one at sign up, etc.

At 204, server system 102 receives a selection of service options and an image representation for the service. The selection of service options may be related to configuring the service, which may include the type of service, such as which brand of service is selected, and other options (e.g., ad free, ads, etc.). The image representation may be a default image representation or a customized image representation.

At 206, server system 102 determines the type of image representation that was selected. For example, server system 102 determines if a default image representation is selected or a user customized image representation has been created. The default image representation may be determined if one of the default image representations was selected. The user customized image representation may be determined if any user customization information was received for the image representation. Also, the image representation that is received may be analyzed to determine whether it is a default image representation or includes some user customization information. The image representation may be compared to default image representations to determine whether one of the default image representations are matched. If no default image representations are matched, then server system 102 may determine that a user customized image representation has been received.

At 208, server system 102 performs an analysis of the image representation based on the type to extract features from characteristics of the image representation. As discussed above, a classification of default image representations or a machine learning recognition of user customized image representations may be performed to determine the image features. The default image representation may be associated with a fixed set of values for the image features. The values for the image features for user customized image representations may be determined using machine learning recognition.

At 210, server system 102 stores the image features, such as mood, color, brand preferences, etc., for the user account. The stored image features may be used later to determine user personalization actions.

### User Personalization Action Generation

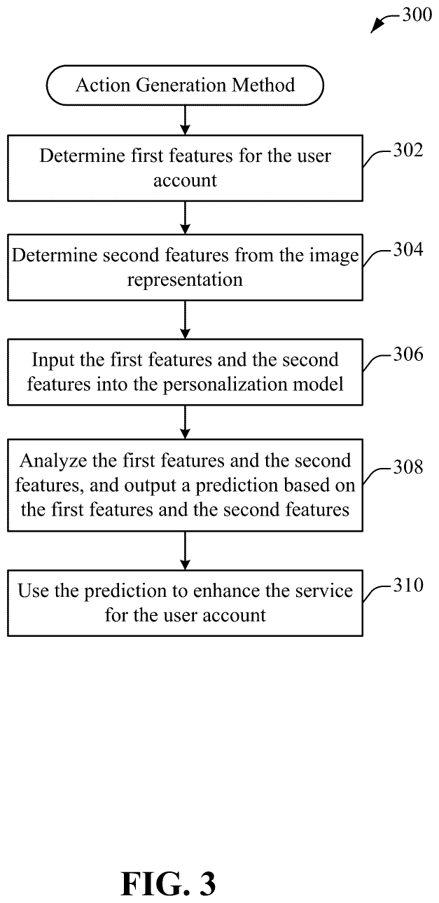

FIG. 3 depicts a simplified flowchart 300 of a method for determining user personalization actions according to some embodiments. At 302, server system 102 determines first features for the user account. The first features may include features other than those determined from the image representation, such as features associated with the user account. For example, the first features may include a generation classification (e.g., millennials, generation X) of the user account, a category in which the user account is classified, or other features. Other information may be used for features, such as information from other services, such as which movies, books, or other items that the user account has purchased, a store in which image representations were most frequently purchased by the account, which rides were which image representations were gone on at a park, which activities for cruises did the user account book, which themed rides were taken or themed restaurants were dined in, which branded clothing was purchased, favorite titles, favorite brands, etc. Generic features that are used across multiple user accounts may also be used.

At 304, server system 102 determines second features from the image representation. The second features may be the values for the image features that were determined from the image representation as described above. The second features may be different from the first features in that the second features are determined from the image representation, whereas the first features are not determined from the image representation.

At 306, server system 102 inputs the first features and the second features into the personalization model 116. At 308, personalization model 116 analyzes the first features and the second features, and outputs a prediction based on the first features and the second features. For example, the prediction may categorize the user account into categories, such as an age range, brand, etc. For example, a category of an age range is predicted from second features of the image representation, such as second features for a cartoon character may indicate an age range of 5-12. Also, a content type of science fiction may be based on the second features of a fantasy character. The category is then used to adjust the user interface, such as to show larger tiles with science fiction content. In other examples, but not limited to, the prediction may be used to determine the user personalization action, such as the prediction is to increase the size of certain tiles for certain science fiction content or other user interface designs using the science fiction theme. Personalization model 116 may also use a distance from second features to instances of content to determine categories. For example, an image representation from a first brand may have a smaller distance to an instance of content in a first category for science fiction compared to an instance of content in a second category for children's shows.

At 310, server system 102 uses the prediction to enhance the service for the user account. For example, server system 102 may use the user personalization action to adjust the user interface, such as rearranging the layout of the user interface, personalizing the background image, changing a color scheme of the user interface, etc. In some examples, the system may determine a metric based on image representation characteristics and user interface characteristics. Personalization model 116 can then be used to determine optimal user interface characteristics for each user, based on user's image representation selection, in order to optimize the metric. This allows for the automatic personalization of the interface by correlating image representation characteristics to user interface characteristics. In some examples, the system could determine that background A leads to better retention than background B. But personalization model 116 may determine that this is mostly true for all users except those who picked a certain type of image representation. For the users in the exception, personalization model 116 determines that background B is actually better. So when a new user selects their image representation, the system would either show background A or B based on the selection in order to maximize retention. This improves the user interface that is presented to users.

The following will discuss the training that can be performed.

### Training

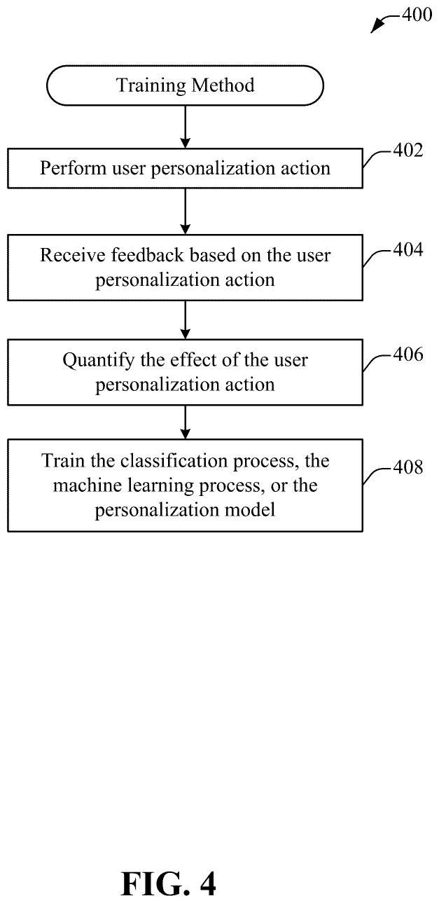

FIG. 4 depicts a simplified flowchart 400 of a method for performing training according to some embodiments. At 402, server system 102 performs a user personalization action. For example, the user personalization action may adjust aspects of the user interface, provide a recommendation of content, or perform other actions.

At 404, server system 102 receives feedback based on the user personalization action. For example, the feedback may be based on the user performing some action, such as selecting content on the adjusted user interface, not performing an action, such as not selected content or changing a personalization theme, etc.

At 406, server system 102 may quantify the effect of the user personalization action. For example, a reward value may be used that may quantify whether the effect is positive, negative, or some other evaluation value (e.g., a range of values). For example, the user interface may be adjusted based on the image features, and the user account may interact with some sections of the user interface that were emphasized. The effect of this personalization may be measured, such as a reward may be positive if a user account selected content in emphasized sections of the user interface or negative if the user account did not select the content. The negative feedback may down-weight second features to indicate the characteristics of the image representation may not be useful to prediction the personalization that was provided.

At 408, service system 102 trains the classification process, the machine-learning process, or the personalization model 116. In the training, the parameters may be adjusted based on the reward values, such as positive outcomes may cause parameters to be adjusted to favor those outcomes when respective image features are encountered or negative outcomes may cause parameters to be adjusted to disfavor those outcomes when respective image features are encountered. Other training may also be appreciated in the process, such as different default image classifications may be generated based on the feedback. Also, the feedback may be used to determine which features were valuable and those features may be used to fine-tune the features. For example, the features of a number of characters on the image is very important, so a new feature is determined for the type of interaction the multiple characters are engaging in on the image, such as laughing, fighting, etc. Also, if a feature of a happy/sad emotion is important, a more robust set of emotions may be used. The determination of the new features may be determined automatically by a model that analyzes the existing set of features and the feedback, and outputs new features to use. This may improve the features that can be used to represent image representations, which improves the personalization.

In some cases, the user account may change image representations. Also, over time, as the user uses the service, the image representation features may not be as important because more information is known about the user, such as the user's watch history of content. The following describes the use of weights to determine the user personalization action according to some embodiments.

### Weight Adjustment

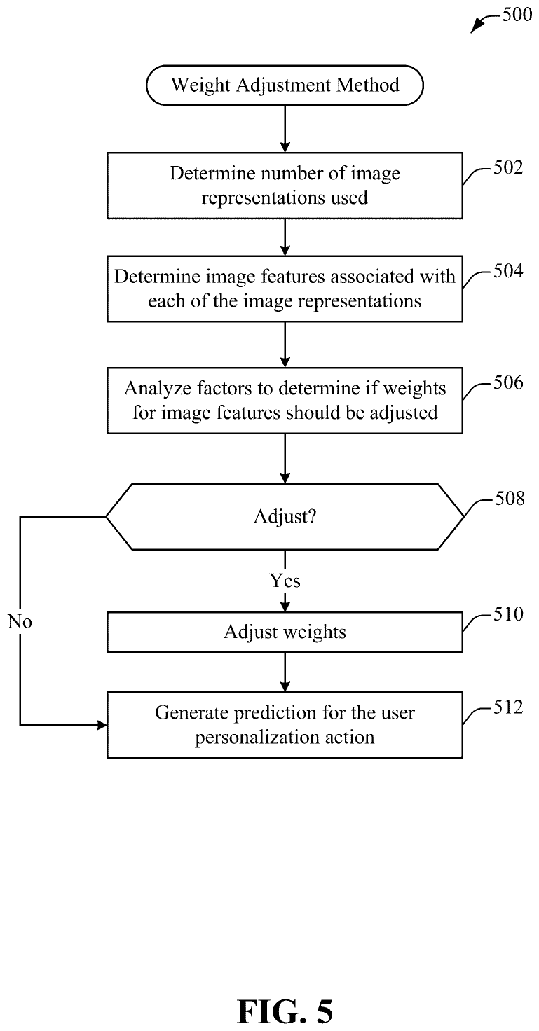

FIG. 5 depicts a simplified flowchart 500 of a method for adjusting weights for image features according to some embodiments. Weights may be used to weight image features. The weights may be adjusted based on different factors, such as when multiple image representations are used over time or concurrently, or as time passes and more information is known about the user.

At 502, server system 102 determines a number of image representations that are used for a user account. For example, the user account may use a first image representation when signing up for the service. Then later on after using the service, the user account may select another image representation. The image representations that are selected may be from a default image representation, a user customized image representation, or a combination of both.

At 504, server system 102 determines image features associated with each of the image representations. For example, the image representations that are determined may be based on the classification process or machine learning recognition, or the classification process and machine learning.

At 506, server system 102 analyzes factors to determine if weights for the image features should be adjusted. For example, the weights may be adjusted based on an importance of the image features to the user account. In some embodiments, an older image representation that is used may not reflect the current user account preferences compared to a newer image classification. In this case, the weights for the image features of the older image classification may be reduced and the weights for the image features for the newer image representations may be increased. This increases the contribution of the image features for the newer image representations. At 508, server system 102 determines whether the weights should be adjusted. For example, the weights may be adjusted when a new image representation is received or the weights may be adjusted after a period of time has elapsed, such as a duration from the user account creation, an amount of information is received for the user account (e.g., a watch history grows beyond a number of watched titles), or other time periods. In some examples, the image features may be weighted less as time passes after the initial sign up. For example, the first features as described at 302 in FIG. 3 may become more important than the image features for the image representation after more information for the user account using the service is received. The information from the user account using the service may become more valuable to generate predictions for user personalization actions as more information is received for the user account.

When multiple image representations are used, the weights may be adjusted inversely proportional to the time since the past image representations were used. Also, there may be multiple image representations for different profiles that are current. For example, a user account may have multiple profiles with multiple image representations. The image features for the multiple image representations may be combined. In other embodiments, depending on the use time of each profile, the image features may be weighted. For example, image features for a profile that is used more may be weighted higher than image features for a profile that is used less. Also, if there is a large number of image or of image representations that have been used for a profile, then, the image features for the profiles may be down-weighted as they may not be as important compared to the features for the user account.

If the weights should be adjusted, at 510, server system 102 adjusts the weights for the image features. For example, some weights for some image features may be adjusted, or all the weights may be adjusted. Depending on the factors, different weights may be adjusted. For example, some image features that offer less insight over time may have their weights reduced while image features that are not affected by time do not have their weights reduced. After adjusting the weights, the process proceeds to 512. Also, if the weights should not be adjusted, the process proceeds to 512. At 512, the server system 102 generates a prediction for the user personalization action. The prediction may be a number between a range (e.g., 0-1), which can be labelled a “probability”, “propensity”, or “score”. The prediction may indicate the relative value to the user account, such as the probability the user account is interested in product A, product B, etc.

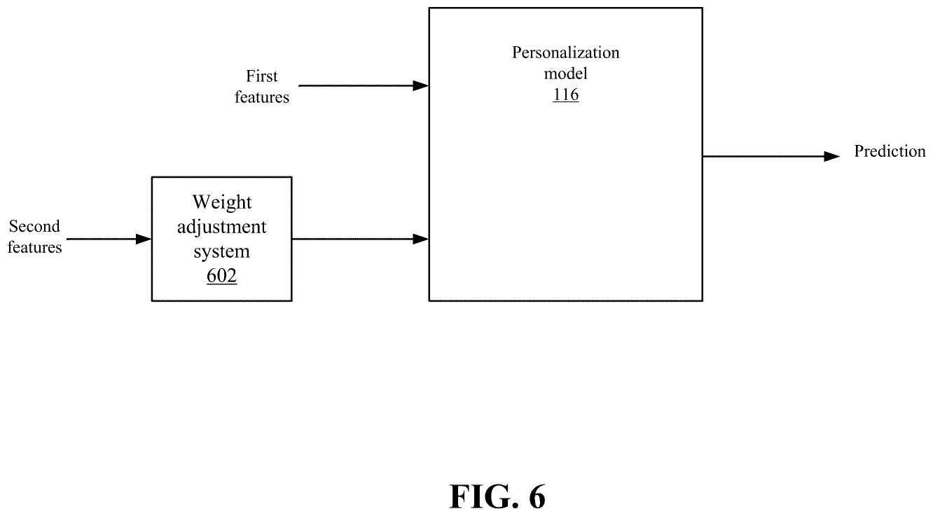

FIG. 6 depicts a more detailed example of personalization model 116 according to some embodiments. Personalization model 116 receives first features and second features as input. As discussed above, the first features may not be associated with the image representation while the second features are determined based on characteristics of the image representation. A weight adjustment system 602 may receive the second features, and determine whether weights should be used to adjust the second features. Weight adjustment system 602 may consider different factors as discussed above to determine whether to adjust weights. When weights should be adjusted, weights adjustment system 602 adjusts the second features and inputs the weighted second features into personalization model 116. Then, personalization model 116 may analyze the weighted second features and the first features.

### Conclusion

The use of the image features for the image representations may provide a much better service experience especially in the beginning of the use of the service. Also, a more customized service may result in a more satisfied user account, which may generate a longer use time of the service and longer tenure. Also, image representations that are more successful may be emphasized and provided to new user accounts that sign up. Also, other services for the company may be provided with image representations that result in better experiences for users. For example, the preferred image representations may be provided in other experiences, such as in communications, printed tickets, room decor offerings, etc.

### System

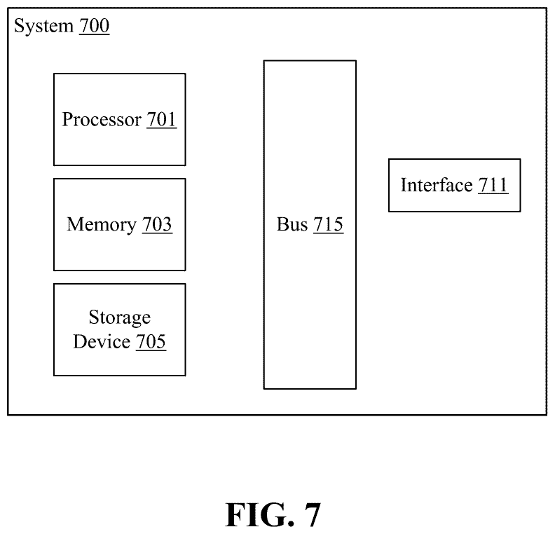

FIG. 7 illustrates one example of a computing device according to some embodiments. According to various embodiments, a system 700 suitable for implementing embodiments described herein includes a processor 701, a memory 703, a storage device 705, an interface 711, and a bus 715 (e.g., a PCI bus or other interconnection fabric.) System 700 may operate as a variety of devices such server system 102, or any other device or service described herein. Although a particular configuration is described, a variety of alternative configurations are possible. The processor 701 may perform operations such as those described herein. Instructions for performing such operations may be embodied in the memory 703, on one or more non-transitory computer readable media, or on some other storage device. Various specially configured devices can also be used in place of or in addition to the processor 701. Memory 703 may be random access memory (RAM) or other dynamic storage devices. Storage device 705 may include a non-transitory computer-readable storage medium holding information, instructions, or some combination thereof, for example instructions that when executed by the processor 701, cause processor 701 to be configured or operable to perform one or more operations of a method as described herein. Bus 715 or other communication components may support communication of information within system 700. The interface 711 may be connected to bus 715 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving an image representation to represent an account for a service;
analyzing the image representation to extract a set of first features of characteristics of the image representation;
determining a set of second features associated with the account that are different from the set of first features;
inputting the set of first features and the set of second features into a model to generate a prediction for the service; and
using the prediction to perform an action on the service for the account.

2. The method of claim 1, wherein:
the image representation is based on a default image representation from a plurality of default image representations, and
default image representations are provided by the service.

3. The method of claim 2, wherein:
default image representations are associated with the set of first features that are defined for respective default image representations.

4. The method of claim 1, wherein:
the image representation is customized for the account using customization information, and
the customization information is received from a user of the account.

5. The method of claim 4, wherein:
the customization information is used to create the image representation based on a template for the image representation.

6. The method of claim 1, wherein:
the image representation is based on a default image representation from a plurality of default image representations, or
the image representation is customized for the account using customization information.

7. The method of claim 6, wherein analyzing the image representation:
using the set of first features that are defined for the default image representation when the image representation is based on the default image representation; and
extracting the set of first features from the image representation using a recognition model that recognizes features in the image representation when the image representation is customized.

8. The method of claim 1, further comprising:
determining whether the image representation is selected from a set of default image representations or customized by the account.

9. The method of claim 8, further comprising:
when the image representation is selected from the set of default image representations, determining the set of first features that are defined for the respective default image representation; and
when the image representation is created by the account, extracting the set of first features from the image representation using a recognition model that recognizes features in the image representation.

10. The method of claim 1, further comprising:
storing values for the set of first features for the account.

11. The method of claim 1, wherein:
the image representation is received when the account signs up for the service.

12. The method of claim 1, wherein:
a weight is applied to a first feature in the set of first features, and
the weight is adjusted based on an amount of time that has passed since the account signed up for the service.

13. The method of claim 1, wherein the image representation comprises a first image representation, the method further comprising:
receiving a change from the first image representation to a second image representation;
applying a weight to a first feature in the set of first features for the first image representation to generate a weighted first feature; and
using the weighted first feature in the model to generate the prediction.

14. The method of claim 1, the method further comprising:
applying a weight to a first feature in the set of first features for the image representation to generate a weighted first feature, wherein the weight is based on a time elapsed from a time that is associated with the account; and
using the weighted first feature in the model to generate the prediction.

15. The method of claim 1, further comprising:
receiving feedback from performing the action; and
using the feedback to adjust parameters for analyzing of the image representation to extract set of first features or parameters for the model to generate the prediction.

16. The method of claim 1, wherein performing the action comprises:
adjusting an interface for the service based on the prediction, wherein prediction personalizes the interface for the account based on the set of first features.

17. The method of claim 1, wherein the service comprises a first service, the method further comprising:
receiving information from a second service for the set of first features; and
adjusting the set of first features based on the information from the second service to generate adjusted set of first features, and
inputting the adjusted set of first features into the model to generate the prediction.

18. The method of claim 1, wherein the set of second features is not based on the image representation.

2. A non-transitory computer-readable storage medium having stored thereon computer executable instructions, which when executed by a computing device, cause the computing device to be operable for:
receiving an image representation to represent an account for a service;
analyzing the image representation to extract a set of first features of characteristics of the image representation;
determining a set of second features associated with the account that are different from the set of first features;
inputting the set of first features and the set of second features into a model to generate a prediction for the service; and
using the prediction to perform an action on the service for the account.

3. An apparatus comprising:
one or more computer processors; and
a computer-readable storage medium comprising instructions for controlling the one or more computer processors to be operable for:
receiving an image representation to represent an account for a service;
analyzing the image representation to extract a set of first features of characteristics of the image representation;
determining a set of second features associated with the account that are different from the set of first features;
inputting the set of first features and the set of second features into a model to generate a prediction for the service; and
using the prediction to perform an action on the service for the account.
